(19) United States
(12) Patent Application Publication
(10) Pub. No.: US 2019/0247150 A1
(43) Pub. Date: Aug. 15, 2019

(54) DENTAL COMPONENT FOR A DENTAL RESTORATION AND METHOD FOR ASSEMBLING THE DENTAL COMPONENT

(71) Applicant: NOBEL BIOCARE SERVICES AG, Kloten (CH)

(72) Inventors: Thomas Kaup, Affoltern am Albis (CH); Roberto Carretta, Baar (CH); Jörg Weitzel, Rielasingen-Worblingen (DE); Piers Christiansen, Zürich (CH); Raquel Tschopp, Aarau Rohr (CH)

(21) Appl. No.: 16/310,122

(22) PCT Filed: Jun. 16, 2017
(86) PCT No.: PCT/EP2017/064766

§ 371 Date: Dec. 14, 2018

(30) Foreign Application Priority Data
Jun. 17, 2016 (EP) 16175054.2

(51) Int. Cl. A61C 8/00; A61C 13/34; A61C 13/275

(52) U.S. Cl. CPC A61C 8/005; A61C 13/275; A61C 8/0001; A61C 13/34

(57) ABSTRACT

The present invention provides a dental component (20; 120) forming the basis for at least a part of a prosthetic dental arch and comprising at least two subcomponents (21, 22; 121, 122) and a connecting device (30; 130) for compensating an offset in position and/or orientation between the subcomponents (21, 22; 121, 122). Each subcomponent (21, 22; 121, 122) includes a mounting portion (25, 26; 125, 126) for mounting the dental component (20; 120) on at least one dental implant or at least one dental implant analogue (11, 12; 111). The connecting device (30; 130) comprises a rotary compensation means (50, 60; 150, 160) that connects the two dental subcomponents (21, 22; 121, 122).

### TECHNICAL FIELD

The present invention relates to a dental component for creating a dental restoration to be attached to a dental implant as well as a method for using the dental component in a workflow of creating and assembling a dental restoration.

### BACKGROUND OF THE INVENTION

Although dental restorations supported by implants have become an established treatment, one of the remaining challenges is an efficient and accurate positioning of the restoration. Ideally, the longitudinal axes of the implant and a through hole of a dental restoration for fastening said dental restoration coincide. However, in reality, there are several sources of error that result in a sub-optimal alignment between an implant and a dental restoration. Such a sub-optimal alignment may well lead to higher tensions within the bone tissue, the implant or the dental restoration, which may adversely affect the lifetime of the restoration.

In most cases, there is a difference between the location of an implant as planned and the location of the implant as actually implanted in the mouth of a patient. Although this process can be assisted by guidance systems, the implantation itself basically remains manual work with its known drawbacks concerning the precision of placement. Although there may be no significant effect on the immediate result of a treatment any corrections that eventually have to be done after implantation generate additional costs and chair time for the patient. In addition, if no passive fit for a screw used in the treatment can be achieved, tension can be introduced into the screw possibly leading to a screw failure, which may well make further treatments necessary, generating additional costs and chair time for the patient.

The dental situation of a patient such as the amount of available bone and/or hardness of the bone of the mandible and/or maxilla might require the implant to be implanted in a depth and/or direction that requires additional measures in order to fit a dental restoration on top of the implant so that it blends into the remaining teeth.

Providing a dental restoration requires a rather complex workflow, which includes multiple impressions that have to be taken for re-creating the dental situation of the patient, in particular for designing the prosthesis of the tooth or teeth. This workflow also generally requires the involvement of several facilities such as a dental clinic and a dental lab.

In case of a denture that is supported on more than one implant, the difference in angle and insertion depth of these implants has also to be taken into account in order to provide optimum support for the dental restoration. In other words, there is generally work required to level any differences in height or angle between these implants so that loads acting on the dental restoration can be transferred equally efficient into the implants and the underlying bone tissue.

One approach to solve these problems is a high degree of customization. For example, after implantation, the dental restoration may be milled from one piece based on scans of the patient's teeth. However, these solutions generally require expensive CAD/CAM machinery.

Another approach is to use modular systems, which include some kind of spacer that can be placed in between an implant and a dental restoration in order to level any differences in height and/or orientation. However, these systems generally require a high number of different parts to be available that may have to be still adapted by hand in the presence of the patient with the aforementioned drawbacks.

In this respect, it was the objective of US 2008/0241790 A1 to compensate for minor misalignments and misplacements due to production tolerances. The proposed system basically uses a segmented element such as a ball that is placed between the head of an implant screw and an implant so that by tightening the screw, the segmented element gets compressed and deforms outwards. This causes the element to press against the inside of a sleeve, which in turn carries a dental restoration. However, this results in the dental restoration being held by a friction fit that bears the risk of a long term displacement or loosening of this restoration. Also, the deformation is equally applied in the circumferential direction of the segmented ball so that this technique does not resolve any misplacements of the dental implant within the bone tissue of a patient.

### SUMMARY OF THE INVENTION

The above-noted challenges have been approached by the inventors of the present invention on the basis of several objectives. One of these objectives was to eliminate any misalignments and misplacements between a dental implant and a dental restoration. Another objective of the present invention was to provide a system that allows for a customized, i.e. passive, fit of the dental restoration but does not require highly individualized parts in order to build and properly support a dental restoration. Another aim of the invention was to simplify the workflow for creating a dental restoration and, in particular, reduce the chair time and any inconveniences to the patient during treatment.

The solution of the present invention addressing the aforementioned objectives and solving the underlying problems is defined by the appended independent claims and is described in the following in more detail. The dependent claims define additional features of further preferred embodiments.

In the following, the term misalignment is primarily used in relation to a difference in orientation between two components. For example, if two components have to be rotated in relation to each other to make them fit, they are considered to be misaligned. In contrast, the term misplacement is generally used in relation to a difference in position between two components, i.e. two components have to be translated to make them fit.

The terms adjustment, compensation or offset in relation to a misalignment or misplacement between a dental implant and a dental component generally refer to an adjustment that generally cannot be compensated by standard components used in the art.

The present invention differentiates between a dental implant and a dental implant analogue. However, the skilled person will appreciate that this difference does not affect the functionality and effects of the features defined in the present invention. Accordingly, a dental implant can be switched to a dental implant analogue and vice versa. Nonetheless, it will be clear to the skilled person in terms of application that a dental implant may be used as a dental implant analogue, whereas a dental implant analogue cannot be used as a dental implant. Thus, the methods conveyed in the following and in the appended claims do only represent a method of treatment if the dental implant is referred to as a dental implant implanted in the mouth of a patient.

In view of above-noted objectives, the present invention provides a dental component forming the basis for at least a part of a prosthetic dental arch and comprising at least two subcomponents and a connecting device for compensating an offset in position and/or orientation between the subcomponents, wherein each subcomponent includes a mounting portion for mounting the dental component on at least one dental implant or at least one dental implant analogue, and wherein the connecting device comprises a rotary compensation means that connects the two dental subcomponents.

The placement of dental implants or dental implant analogues, the implant analogues reflecting the position and orientation of such dental implants, generally varies from dental situation to dental situation. Thus, any dental component that is to be fastened to at least two implants or implant analogues has to be adapted or custom-fitted in view of this individual dental situation.

In order to avoid having to custom-fit the geometry of each dental component, the present invention simply subdivides the dental component into at least two subcomponents that each can be mounted to a dental implant or dental implant analogue. Nonetheless, in order to make the dental subcomponents form a continuous and rigid dental component for producing a dental prosthesis, the at least two dental subcomponents can be connected to each other. This connection is achieved by the above defined connecting device including a rotary compensation means that is able to compensate an offset in position and/or orientation between the subcomponents. This offset in position (misplacement) and/or orientation (misalignment) is caused by the position and orientation of the subcomponents as defines by the implants, the subcomponents are placed on.

As a result, the dental component can be provided as a cost efficient off the shelf product that can be easily adjusted to comply with the individual dental situation of a patient. This adaptability of the dental component according to the present invention allows for an optimal placement of the implants yet provides a rigid dental component as as basis to create a dental prosthesis.

Since the dental component forms the basis for at least a part of a prosthetic dental arch, the dental component is elongated and preferably curved in order to form the part of the dental arch. Consequently, the connecting device connects two dental subcomponents in their longitudinal direction at ends facing each other.

Preferably, the dental component is a superstructure such as a bridge for three or more teeth, the bridge being fixed with at least two or three implants. More preferably, the dental component is formed as a bar for the treatment of fully edentulous situations. Such a dental component is preferably fixed to two, three, four, five or six implants.

In relation to the present invention and as further described below, the connecting device can partly be integrated in the design of the subcomponent.

In a preferred embodiment, the rotary compensation means of the dental component comprises a rotary joint, preferably two rotary joints, the rotary joint preferably being a ball and socket joint.

A rotary joint has a simple design and in particular two rotary joints installed in series can prevent tension caused by connecting the two dental subcomponents. Further, if a ball and socket joint, i. e. a spherical joint, is used, tension can be prevented around all three degrees of rotation in contrast to, for example, an elastic rotary joint such as a strip of elastic or pliable material, which can also rotate about all three degrees of rotation. Other joints that may be used include hinges, swivel joints and/or pivot joint.

In a particularly preferred embodiment, the connecting device further comprises a linear compensation means for bridging a distance between the two dental subcomponents, the linear compensation means preferably being located between the two dental subcomponents.

An even more flexible adaptation in order to bridge a difference in position and/or rotation between two dental subcomponents that are attached to a dental implant or dental implant analogue is achieved by this embodiment since it allows for a linear compensation with the linear compensation means as defined above. In other words, there is more flexibility in placing the dental subcomponents in relation to the implants or implant analogues along the part of a patient's dental arch that is to be replaced by a dental prosthesis.

The linear compensation means can be part of at least one of the two dental subcomponents to be connected to each other such as a sliding mechanism acting along the longitudinal direction of a subcomponent. However, the linear compensation means is preferably located between the two dental subcomponents, in particular between two rotary joints that connect the two subcomponents, respectively.

In another particularly preferred embodiment, the dental component further comprises a bearing element for mounting one of the dental subcomponents to a dental implant or dental implant analogue, the bearing element having a bearing surface for interaction with a bearing surface of the dental subcomponent and a through hole in the apical-coronal direction, the through hole preferably comprising a thread.

The bearing element is located between the dental subcomponent and the dental implant or dental implant analogue. Although it can be integral with the dental implant or dental implant analogue, the bearing element is preferably designed as a separate part. The bearing surface is located on the coronal side of the bearing element and is in contact with an apical bearing surface of the dental subcomponent. It allows for a compensation of an angular offset or misalignment between the implant and the dental subcomponent.

The bearing surface of the bearing element is preferably designed to allow for rotation about an axis perpendicular to the apical-coronal direction, i. e. the longitudinal axis of the dental implant the bearing element is attached to. The contact between the bearing element's bearing surface and a bearing surface of the dental subcomponent can be a contact at multiple points, a line contact or a surface contact. Preferably, the contact is a surface contact achieved by a spherical bearing surface.

Providing a thread in the through hole of the bearing element allows for a preassembly of the dental component. In the preassembled state, a fastening element such as a dental screw engages the fastening element.

Further, the bearing element may comprise attachment mechanism that provides a stable temporary attachment of the bearing element to the dental implant or dental implant analogue. Thus allows for a better compensation of any relative misalignment and/or misplacement between the dental subcomponents and the implant or dental implant analogue while adjusting the connecting device since a more stable attachment of the bearing element between the bearing element and the dental implant or dental implant analogue can be provided. In other words, the attachment mechanism provides a defined connection between the dental implant or dental implant analogue and the bearing element, which allows for a better correction of a misalignment and/or a misplacement between the dental implant or dental implant analogue and the dental component.

In another embodiment, each of the dental subcomponents comprises at least one hole in the apical-coronal direction, preferably a slotted hole, for insertion of a dental screw.

The hole is preferably a through hole and is provided for attaching the subcomponents to a dental implant or dental implant analogue. Each through hole extends from an apical side to a coronal side of the subcomponent and is dimensioned for an insertion of a fastening element, in particular an implant screw or a temporary screw.

Preferably the hole allows for compensation of a misalignment and/or misplacement that may be present between the dental implant or dental implant analogue and the dental component. Accordingly, the diameter of the hole has a larger cross-section or diameter than necessary to be able to insert an implant screw. Further, the through hole may be formed as a slotted hole. In particular, the largest dimension of a cross-section or a diameter of the dental component's screw hole is 20 to 300%, preferably 50 to 150%, and most preferably 75 to 125% larger than the diameter of the part of the implant screw located in the through hole while being fastened to the dental implant or dental implant analogue. If a bearing element is used in combination with such an oversized hole in a dental component, the through hole of the bearing element may be adapted correspondingly for adjusting the position of a dental subcomponent in transverse direction in relation to the longitudinal axis of the dental screw.

In yet another embodiment, the holes in the subcomponents form a part of the connecting device and are located so as to face each other in order to provide a through hole for insertion of a dental screw, wherein the apertures of the holes facing each other and preferably the apical aperture of the hole of the subcomponent facing the dental implant or the dental implant analogue in an assembled state are each located within a rotary bearing surface.

In this embodiment, the connecting device is formed by end portions of the subcomponents facing each other in the longitudinal direction of the dental component. In order to bring the through holes in communication with each other, the end portions of the subcomponents also face each other in an apical-coronal direction.

The bearing surfaces between the two subcomponents can be formed as described above in relation to the bearing surface of the bearing element. If present, this also applies to the apical aperture of the hole of the subcomponent facing the dental implant or the dental implant analogue in an assembled state. The latter bearing surface is preferably in contact with the bearing surface of a bearing element as previously defined.

If one or both subcomponents include another through hole for attachment to another dental implant, preferably a bearing element as previously defined is placed between this dental implant and the subcomponent. This is particularly advantageous if this through hole is the last through hole along a dental component for mounting to a dental implant or a dental implant analogue. At this position, only one subcomponent is located. Thus, a bearing element makes a rotary compensation available at this location.

This embodiment allows for the compensation of an offset between two subcomponents with a connecting device requiring a minimal amount of parts.

In another embodiment, the dental component comprises a third subcomponent and a second connection device, wherein the first and second subcomponents are coupled via the first connection device and the second and third subcomponents are coupled via the second connection device.

This embodiment allows for an easy and cost efficient adaptation of a dental component used as a basis for creating a dental prosthesis intended to cover at least a major portion of a dental arch. Further, the arrangement of preferably three through holes along the dental component has the advantage that a dental prosthesis can be safely supported on three dental implants or during creation of the prosthesis three dental implant analogues.

In yet another preferred embodiment, the dental component further comprises at least one locking device for locking the connecting device in position and/or orientation.

As described above, the connecting device allows for an adjustment of the position and/or orientation between an implant and a dental component. Once attached, the locking device can lock or maintain this adjustment. In other words, after the adjustment of the orientation and/or position has taken place, transferring the connection assembly into a locked state “records” this adjustment. Thus, the adjusted and assembled dental component can be removed from the dental implant or the dental implant analogue while keeping the aforementioned adjustment in place. This provides any adjustment needed between the dental implants or dental implant analogues and a dental component so that a precise fit between the dental implant and the dental prosthesis is achieved. Further, the removal allows for verifying the fit of the dental component on the implants in the mouth of a patient during treatment and before producing the final dental restoration. The locking device can be a fastening element, such as a screw, that brings at least one compensation means of the connecting device into engagement. As addition or alternative, an affixing means, described in further detail below, may be used to lock a compensation means of the connecting device.

The invention further provides a method for preassembling a dental component including at least two elongated subcomponents, wherein the method comprises the steps of establishing a connection between the at least two subcomponents by assembling a first rotary joint of a connecting device and assembling a second rotary joint of the connecting device, wherein the assembled first and second rotary joints are optionally maintained in an assembled state by bringing the rotary joints into engagement using a fastening element and/or a locking device.

This method applies the above-mentioned advantages of the present invention's dental component. In particular, the application of this method allows for a preassembly of a dental component without any involvement of a patient. Further, being able to provide the dental component in a preassembled state allows for providing the dental component in a sterilized package to a patient. Thus, one of the main drawbacks of multicomponent systems, i.e. requiring assembly steps in the presence of the patient and, thus, increased exposure to the environment, has been successfully eliminated.

Preferably, the engagement of the rotary joints maintains the dental component in an assembled state so that the subcomponents and the connecting device form a unit, yet allows for an adjustment of these joints. In other words, the dental component is not locked so that the preassembled dental component can be adjusted to a dental situation. Afterwards, the dental component is transferred to its rigid state by locking the connecting device using at least one of the options listed above.

In a preferred embodiment of the method, the fastening element is a dental screw engaging a bearing element of the second joint.

In this embodiment, the dental component is preassembled and maintained as a unit that can easily be handled and placed on at least two dental implants or dental implant analogues. By engaging the bearing element, the portions of the subcomponents, which form at least part of the connecting device and which are located between the head of the dental screw and the bearing element, are mounted to each other.

In another embodiment, the method further comprises the step of assembling a linear compensation means of the connecting device for adjusting the distance between the first rotary joint and the second rotary joint by bringing a first part including the first rotary joint into engagement with a second part including the second rotary joint, wherein the linear compensation means can preferably be locked using a locking device.

The linear compensation means comprises two parts that can be displaced relative to each other in order to adjust the distance between the first rotary joint and the second rotary joint. The displacement can, for example, be achieved by sliding the two parts relative to each other in the longitudinal direction of the dental component or by a threaded engagement between the first part and the second part of the linear compensation means so that a relative rotation between these parts causes a change in distance. Preferably, the linear compensation means can also be locked by a locking device for preassembling the linear compensation means and/or recording the adjustment of the connecting device.

The invention also provides a method for fitting a dental component to at least two dental implants or dental implant analogues for the production of a dental prosthesis, the method comprising the steps of obtaining a dental component comprising at least two subcomponents, the two subcomponents being coupled by a connecting device, mounting the subcomponents onto the dental implants or dental implant analogues, and adjusting the connecting device to compensate for an offset in position and/or orientation between the two dental implants or dental implant analogues.

The at least two dental implants or dental implant analogues are oriented and positioned according to an implantation site in the mouth of a patient and, thus, establish the situation, the dental component has to be adapted to. The fitting of the dental component may take place directly at the implantation site or on a model that represents the placement of the dental implants within the upper or lower jaw bone of a patient. The adjustment of the connecting device in order to compensate a misalignment and/or misplacement between the subcomponents is simply achieved by placing or mounting the subcomponents, which are preferably preassembled, to the connecting device onto the dental implants or dental implant analogues, preferably using dental screws. Although the dental component is preassembled, it is not fastened so that the subcomponents are able to move relative to each other.

In a preferred embodiment, the method further comprises the step of retaining the adjustment of the connecting device using a locking device, such as a screw, and/or affixing means, wherein the affixing means is in particular a thermosetting polymer, preferably chosen from at least one of the following: wax, acrylic, resin.

As already described above in relation to the locking device, engaging the locking device allows to record the adjustment of the connecting device. This also applies when using an affixing means as defined above as an alternative or in combination to the locking device. In any case, the recording of the adjusted dental component allows the removal of the dental component from the dental implant or dental implant analogue for further processing, for example for building up the dental prosthesis on the basis of the dental component or checking the fit of the dental component to the implantation site. In other words, the position and orientation of the dental component in relation to the dental implant or dental implant analogue can be maintained even when the dental component is detached from the implant or implant analogue.

In another particularly preferred embodiment, the method further comprises obtaining at least two, preferably three transfer abutments, each transfer abutment corresponding to a dental implant and indicating the position and/or orientation of the dental implant, and creating a working model by attaching an implant analogue to each transfer abutment and fixing the at least two implant analogues in the working model, preferably by embedding the dental implant analogue in a moldable material.

This part of the method provides a model of the dental situation of a patient that can be used for adjusting the position and/or orientation of a dental component relative to a dental implant analogue as described above. This has the advantage that it can be controlled during the creation of the prosthesis as often as necessary without bothering the patient if the precise fit of the dental component in relation to the at least one implant analogue representing the at least one dental implant in the patient's mouth has been maintained during further processing.

The transfer abutments are fixed in relation to each other while being installed on the respective dental implants of a patient. After removal of the fixed transfer abutments and in order to fix the implant analogues in a model, the implant analogues are preferably embedded in a moldable material while this material is still in the liquid state. In other words, the implant analogues are immersed in this material before the material sets or cures and, thus, transfers to a solid state that keeps the implant analogues in place. As moldable material, a resin or gypsum may be used. After the moldable material is set or cured, the transfer abutments are removed. As a result, the dental implant analogues of the working model represent the positions and/or orientations of the implants in the mouth of the patient.

In yet another embodiment, the method further comprises the step of producing a dental prosthesis on the basis of the dental component, preferably with the subcomponents being fixed in relative position and orientation to each other and being optionally attached to the dental implant analogues using a temporary screw.

Since the dental prosthesis is built on the basis of a precisely fitting dental component, a precise fit of the final dental prosthesis using the dental component as framework is achieved. During production, a temporary screw may be used that comprises a head with the dimensions of a screw hole. This head will be embedded in the material the dental prosthesis is formed of. Naturally it is also possible to use an implant screw for fixation. In addition or as an alternative, an attachment mechanism may be used. After removal of the temporary screw, there is a hole present in the dental prosthesis through which the dental screw can be inserted in order to fasten the dental prosthesis to the implants or implant analogues.

In another preferred embodiment, the method also comprises the steps of obtaining data about intraoral jaw relation records for a vertical dimension of occlusion and a centric relation, and applying these records to an articulator for producing the dental prosthesis.

This measure further improves the fit of the resulting dental prosthesis, in particular if the dental prosthesis replaces more than three teeth. This results in a significant influence of the prosthesis on the kinematics of the jaw. Further, this embodiment enhances the production of the dental prosthesis without increasing the chair time of the patient since the occlusion of the jaw and in particular the antagonists of the dental prosthesis are accounted for so that any adjustment of the prosthesis after placing it in the patient's mouth are reduced to a minimum.

In another embodiment, the method further comprises the step of fixing the dental prosthesis including the dental component to at least one dental implant implanted into the mandible or maxilla of a patient using implant screws.

This step finalizes the treatment of a patient and provides a dental replacement using less chair time, mainly thanks to the precise recording of the orientation and position of the implant relative to the dental component with the support of the present invention's connection assembly.

### BRIEF DESCRIPTION OF THE FIGURES

The following figures illustrate preferred embodiments of the present invention. These embodiments are not to be construed as limiting but merely to enhance the understanding of the invention together with the following description. In these figures, same reference numerals are used for features that are identical or have an identical or similar function and/or structure. This also applies to reference numerals of features that are identical except for the first digit, which indicates the application of the feature in another embodiment. In the following a short description will summarize the content of these figures.

FIG. 1 illustrates a sectional view of a first embodiment of a dental component according to the present invention.

FIG. 2 illustrates a sectional view of a second embodiment of a dental component according to the present invention.

FIG. 3 illustrates a sectional view of a preferred detail that is applicable to either of the embodiments shown in FIGS. 1 and 2, the detail using washers to compensate for a misalignment and/or misplacement of the head of a fastening element in relation to a dental component.

FIG. 4 shows transfer abutments that are used in a preferred embodiment of the invention for modeling a patient's dental situation during the production of a dental prosthesis on the basis of a dental component.

### DETAILED DESCRIPTION OF PREFERRED EMBODIMENTS

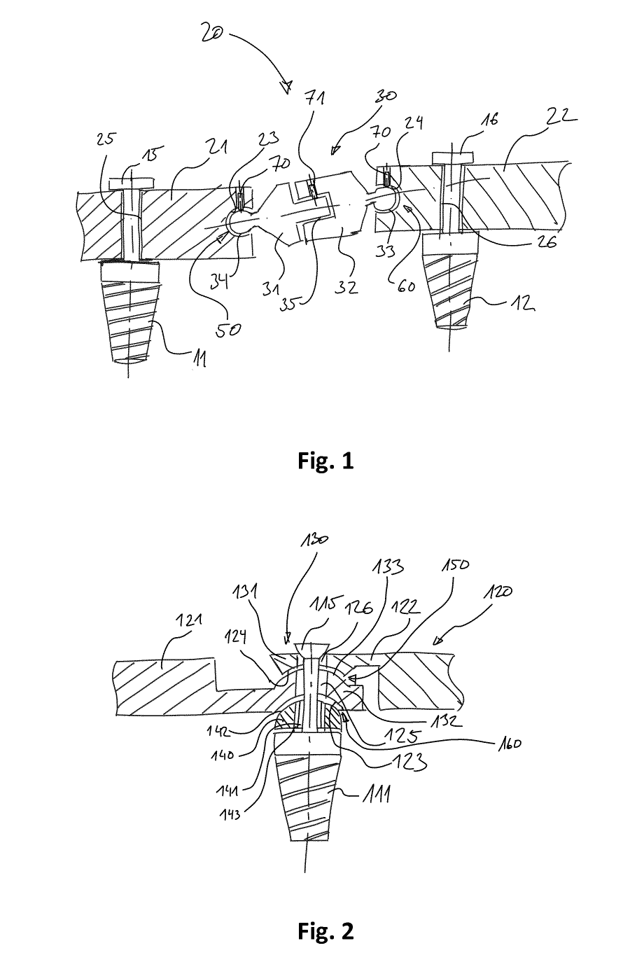

The dental component 20 shown in FIG. 1 as well as the dental component 120 shown in FIG. 2 are used in building up a dental prosthesis for the replacement of teeth in a mandible or maxilla. In other words, the dental prosthesis serves serves as as replacement of at least a part of a dental arch. In order to provide efficient support for the dental prosthesis, the dental component 20, 120 is attached to at least two, preferably three dental implants 11, 12, 111. Nonetheless, as will be appreciated by the skilled person, the dental component 20, 120 may also be intended for a connection with more than two implants, such as three, four, five or six implants for creating a dental prosthesis. This is simply achieved by adapting the size of the dental component 20, 120.

Turning to FIG. 1, the dental component 20 comprises two dental subcomponents 21, 22. Since the dental component 20 is intended for a dental restoration of at least a part of a dental arch, it is elongated and may be curved. This also applies to the subcomponents 21 and 22. The subcomponents 21, 22 are connected to each other with a connecting device 30. More specifically, the connecting device connects two ends of the subcomponents 21, 22 that face each other. In this embodiment, each subcomponent 21, 22 preferably comprises only one through hole 25, 26 for an attachment to a dental implant 11, 12 using a fastening element 15, 16, preferably an implant screw.

On the side of the through hole 15, 16 facing the dental implant or dental implant analogue 11, 12, i. e. the apical mouth of the through hole, the subcomponent 21, 22 may comprise an adapter portion (not shown) for engaging a dental implant or dental implant analogue 11, 12. For example, the adapter portion may be configured to engage a conical inner surface and/or indexing means of an implant 11, 12, the indexing means preventing a rotation between the implant 11, 12 and the dental subcomponent 21, 22.

In the exemplary embodiment of FIG. 1, the longitudinal axis of the screw 15, 16 and the dental implant 11, 12 is perpendicular to the longitudinal direction of the subcomponent 21, 22 when fitted into the through hole 25, 26. Thus, in the embodiment illustrated in FIG. 1, there is no significant compensation concerning a misalignment between the dental subcomponents 21, 22 and the implants 11, 12 possible.

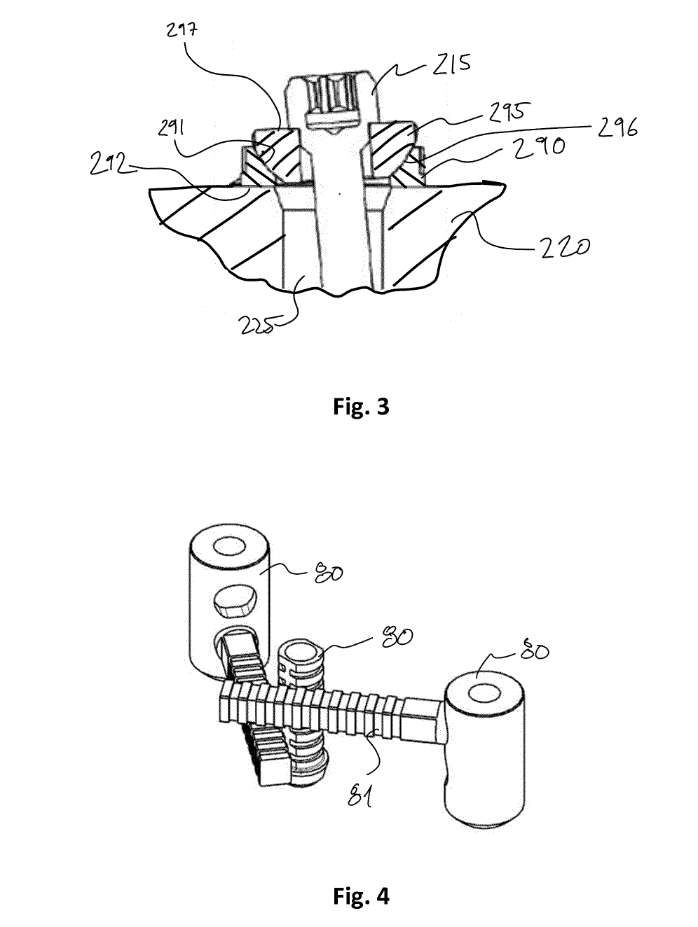

However, if desired, a bearing element 140, as shown in FIG. 2 and explained in more detail further below, may be placed between either or both dental subcomponents 21, 22 and the corresponding implants 11, 12 in order to allow for such a compensation. In this case, the dental screws 15, 16 as well as the through holes 25, 26 will be designed accordingly. More specifically, the through holes 25, 26 will be dimensioned in order to allow for the shafts of the screws 15, 16 to be placed in an angle in relation to the longitudinal axis of the corresponding through hole 25, 26. Further, the head of the dental screws 15, 16 should be formed as described in more detail below in relation to FIG. 2. Additionally, a first washer 290 or alternatively a first washer 290 and a second washer 295 can be provided as described in more detail in relation to FIG. 3.

Nonetheless, in the embodiment of FIG. 1, the connecting device 30 is generally sufficient to compensate a misalignment and/or misplacement between the subcomponents 21, 22, which keeps the configuration of the dental component 20 as well as its installation and adjustment on an implant or implant analogue 11, 12 simple and easy to handle.

Further, the through holes 25, 26 may be dimensioned to allow for a relative movement between the screw shafts of either of the dental screws 15, 16 and the corresponding subcomponent 21, 22 in a plane perpendicular to the longitudinal axis of the screws 15, 16. If a bearing element 140 (cf. FIG. 2) is placed between at least one of the implants or implant analogues 11, 12 and the corresponding subcomponent, preferably with at least one washer placed between the screw head of the engaged screw 15, 16 and the coronal side of the corresponding subcomponent, an inclined placement of either of the screw shafts of the dental screws 15, 16 in relation to the longitudinal axis of the corresponding through hole 25, 26 is also possible.

Preferably, the through hole 25, 26 is formed as a slotted hole, wherein the larger dimension of the hole's cross-section extends in the longitudinal direction of the corresponding subcomponent 21, 22. The dimension of the diameter or larger dimension of the through hole 25, 26 may be chosen as defined above.

Another possibility to allow for an increase in cross-section of a through hole 25, 26 is the usage of a washer as described in relation to FIG. 3. If either of the through holes 25, 26 is configured with an increased cross-section, there may be no need for a linear compensation means 35, which will be described in more detail below, or the possible range for compensating is simply extended.

Further, the connecting device 30 of FIG. 1 comprises a rotary compensation means in the form of two rotary joints 50, 60. As can be taken from FIG. 1, the rotary joints 50, 60 are preferably configured as ball and socket joints. Even more preferably, the ball and socket joints are mounted by snapping the ball into the sockets. Alternatively the rotary joint maybe already assembled during manufacturing, for example by using 3D printing. Using this technique, one side of the rotary joint can be manufactured enclosed by the other side of the rotary joint. In this manner, the connecting device 30 as well as the subcomponents 21, 22 can be preassembled and maintained as a unit that can be easily handled during treatment of a patient.

As an alternative or an addition to the snap fit, at least one locking device 70 may be provided at the joints 50, 60. Preferably, the locking device 70 is engaged in order to keep the rotary joints 50, 60 assembled. This is preferably achieved by the engaged locking device 70 narrowing down the opening of the recess or concave bearing surface 23, 24 so that the convex bearing surface 33, 34 of the corresponding rotary joint 50, 60 is no able to exit this recess. Further engagement of the locking device may then lock the corresponding rotary joint 50, 60.

Since the bearing surfaces 23, 24 in the exemplary embodiment of FIG. 1 are provided in the end surfaces of the dental subcomponents 21, 22, the dental subcomponents 21, 22 form a part of the connecting device 30. As a result of this arrangement, the rotary joints 50, 60 connect the subcomponents 21, 22 in series, i. e. in the longitudinal direction of the dental component 20.

As already mentioned above, the connecting device 30 may also comprise a linear compensation means 35 in order to compensate for a distance between the dental subcomponents 21, 22 connected to the dental implants or dental implant analogues 11, 12. In FIG. 1, the linear compensation means 35 is located between the rotary joints 50, 60. Instead of being integrally formed, the bearing surface 34 of the rotary joint 50 is comprised in a first part 31 of the connecting device 30 and the bearing surface 33 of the rotary joint 60 is comprised in a second part 32 of the connecting device 30. As described above, the two parts 31, 32 may be slidably arranged in relation to each other so that the distance between the rotary joints 50, 60 can be adapted to the distance between the dental subcomponent 21, 22 in order to avoid undesired tensions. Alternatively, the displacement of the linear compensation means in the longitudinal direction of the dental component 20 may be achieved by a threaded connection between the parts 31, 32 of the linear compensation means 35 so that a relative rotation between the two parts 31, 32 results in a change in distance between the first rotary joint 50 and the second rotary joint 60.

In any case, the linear compensation means can be preferably locked in position using a locking device 71, in particular to record an adjustment of the connecting device 30.

As already mentioned above, the dental component 20 may be pre-assembled at the production site since it can be produced as an off the shelf product. Naturally, preassembly may also take place in a dental lab or a dental office.

The preassembly is performed by assembling the bearing surfaces 23, 34 of the first rotary joint 50 and the bearing surfaces 24, 33 of the second rotary joint 60. Further, the locking devices 70 may be brought into engagement so that they are ready to lock the corresponding joint after an adjustment of the connecting device 30. In other words, a locking device 70 is preferably only engaged to such a degree that the rotary joints 50, 60 are coupled to each other still allow for a relative movement between the bearing surfaces.

If a linear compensation means 35 is provided, the two parts 31, 32 are connected and the locking device 71 is engaged to allow for a relative linear movement of the two parts 31, 32. In case of a linear sliding mechanism, the parts 31, 32 are preferably locked in position in relation to each other to keep the dental component 20 assembled.

The dental component 20 is installed preferably preassembled on at least two dental implants 11, 12. As shown in FIG. 1, the dental implants 11, 12 may differ in their position in the apical-coronal direction, which is referred to as being misplaced. They may also differ in their orientation, i.e. they may be misaligned. In order to compensate this misplacement and/or misalignment, one of the subcomponents 21, 22 is mounted to an implant or implant analogue 11, 12 using a dental screw 15, 16 inserted into the through hole 25, 26 of the dental subcomponent 21, 22 and brought into engagement with the dental implant or implant analogue 11, 12. Before installing the second dental subcomponent 22 to the second dental implant or implant analogue 12, any locking device 70, 71 should be engaged but not in a locked position so that the connecting device 30 is able to adjust to the relative position and/or orientation between the two dental subcomponents 21, 22. This adjustment takes place while attaching the second subcomponent 22 to the second dental implant or implant analogue 12 with the second fastening element 16, preferably an implant screw. With both dental subcomponents 21, 22 being attached to the dental implants or dental implant analogues 11, 12, the dental screws 15, 16 can be tightened.

In the next step, the adjustment of the connecting device 30 can be recorded by bringing the locking devices 70 of the rotary joints 50, 60 and, if available, the locking device 71 of the linear compensation means 35 into a locked position. Instead of using a locking device 70, 71, it is also possible to use an affixing means as described above to lock the adjustment of the connecting device 30. After being locked, the dental component 20 can be removed from the dental implants or dental implant analogues 11, 12 and can be easily and conveniently handled for further processing.

In the embodiment of a dental component 20 shown in FIG. 1, preferably only one through hole for attachment to a dental implant or dental implant analogue 11, 12 is provided per subcomponent. In this manner, any misplacement and/or misalignment can be easily compensated between dental implants or dental implant analogues using the connecting device 30.

Turning to FIG. 2, another embodiment of a dental component 120 also comprises at least two dental subcomponents 121, 122. In contrast to the embodiment shown in FIG. 1, the dental component 120 of FIG. 2 comprises a connecting device 130 that is fully integral with the dental subcomponents 121 and 122. More specifically, a rotary compensation means is provided as a rotary joint 150, wherein the bearing surfaces 124 and 133 of the rotary joint 150 are provided as part of the subcomponents 120 and 121, respectively.

As illustrated in FIG. 2, the rotary compensation means is preferably supplemented by a bearing element 140. The bearing element 140 comprises a coronal bearing surface 142 and a through hole 141 in an apical-coronal direction. The through hole 141 is preferably provided with a thread 143 that is used in relation to the preassembly of the dental component 120 as described in more detail further below.

Preferably, the bearing element 140 is provided with an attachment mechanism for engaging a dental implant or a dental implant analogue in a detachable manner (not shown). The attachment mechanism of the bearing element 140 engages the dental implant or dental implant analogue 111 with a form-fit, preferably a snap-fit and/or a friction fit. This way, the attachment mechanism can provide a defined attachment of the fastening element to the dental implant or dental implant analogue 111, which is particularly advantageous for a fast testing of the dental component's fit. Such an attachment mechanism may also be provided to the dental component 20 illustrated in FIG. 1. The attachment mechanism may also include an adapter portion as described above.

The coronal bearing surface 142 of the bearing element 140 forms a second rotary joint 160 when being coupled or in contact to the apical bearing surface 123 of the subcomponent 122 in addition to the first rotary joint 150 being formed by the apical bearing surface 124 of the subcomponent 122 being in contact with the coronal bearing surface 133 of the subcomponent 121. Within the bearing surfaces 124 and 133 of the subcomponents 122 and 121 holes 126 and 125 are formed, respectively. The holes 125 and 126 extend through the subcomponents 121 and 122, respectively.

The holes 125 and 126 are arranged in the aforementioned bearing surfaces 122, 123, 133, 142 on top of each other so as to form a through hole 125, 126 for insertion of a fastening element 115, in particular an implant screw, and bringing the fastening element 115 into engagement with the dental implant or implant analogue 111. If a bearing element 140 is provided as part of the dental component 120, the implant screw 115 also passes through the through hole 141 of the bearing element 140 when being engaged with the dental implant or implant analogue 111. Further, if a thread 143 is provided in the through hole 141 of the bearing element 140, the implant screw 115 may also be engaged with the thread 143 after preassembly of the dental component 120, as will be explained in further detail below.

The through hole 126 is oversized in relation to the shaft of the fastening element 115 as already described above in more detail in relation to the through holes 15 and 16 (cf. FIG. 1). Thus, the through hole 126 allows for a compensation of a misalignment and/or misplacement of the subcomponent 122 in relation to the dental implant or dental implant analogue 111.

Further, if a bearing element 140 is provided on top of the implant or implant analogue 111, the through hole 125 is also oversized due to the same reason. In contrast, the through hole 141 of the bearing element 140 does not have to be oversized since its position relative to the dental implant or implant analogue 111 is constant. However, if a thread 143 is provided in the through hole 141 of the bearing element 140, the hole 141 and the thread 143 are configured so as to allow an engagement of implant screw 150. Nonetheless, if the through hole 141 is oversized, it allows for a compensation of a misplacement between the dental implant or implant analogue 111 and the dental component 120 as has already been described above in more detail.

The coronal bearing surfaces 142 of the bearing element 140 and/or the coronal bearing surface 133 of the subcomponent 121 is preferably bigger than the corresponding apical bearing surface 123 of the subcomponent 121 and the apical bearing surface 124 of the subcomponent 122 in order to allow a relative rotation.

Like the dental component 20 illustrated in FIG. 1, the dental component 120 illustrated in FIG. 2 can be provided as a preassembled off the shelf product. In order to allow for a preassembly, the dental component 120 comprises a bearing element 140 including a through hole 141 provided with a thread 143. During preassembly, the first rotary joint 150 located between the first subcomponent 121 and the second subcomponent 122 as well as the second rotary joint 160 located between the second subcomponent 122 and the bearing element 140 are coupled, i. e. assembled. Then, a fastening element 115 such as an implant screw or the above mentioned temporary screw is inserted into the through holes 125 and 126 in a coronal-apical direction and is brought into engagement with the thread 143 of the bearing element 140. Consequently, the dental component 120 can be provided as a pre-assembled unit, wherein the rotary joints 150, 160 and the linear compensation means 135 in the form of correspondingly sized through holes are preferably not locked.

When attaching the preassembled dental component 120 to a dental implant or implant analogue 111, the thread of the fastening element 115 preferably disengages the thread 143 of the bearing element 140 before engaging a thread of the dental implant or dental implant analogue 111 (not shown).

As with the dental component 20, the adjustment of the dental component 120 in order to compensate for a misalignment and/or misplacement of the subcomponents 121 and 122 in relation to the dental implant or implant analogue 111 is simply achieved by attaching the preassembled dental component 120 to the dental implant or implant analogue 111. Although forming a unit, the preassembled dental component 120 is loose and allows for a relative movement of the subcomponents 121 and 122 and the bearing element 140 in relation to each other. Thus, the adjustment will automatically take place when attaching the dental component 120 to the dental implant or implant analogue 111 and tightening the screw 115.

In order to keep or record the adjustment when detaching the dental component 120 from the implant or implant analogue 111, preferably the aforementioned affixing means are applied in order to lock the subcomponents 121 and 122 as well as the bearing element 140 in position and orientation relative to each other. Like the dental component 20, this has the above noted advantages during further processing for producing the final dental restoration on the basis of the dental component 120. For example, the adjusted and locked dental component 120 may be attached to the dental implant or dental implant analogue 111 using, for example, a fastening element 115, such as an implant screw, in order to verify the precise fit of this arrangement. If a dental implant analogue 111 is used, the steps of the method may be executed on a model, which may be created as described further below, in a dental lab or in absence of the patient at a dental office.

FIG. 2 illustrates the dental component 120 as being connected to only one implant or implant analogue. However, the skilled person will appreciate that at either end of the section of the dental component 120 shown, another subcomponent and, thus, implant or implant analogue may be installed as the implant or implant analogue 111. If an end of a subcomponent is not connected to another subcomponent, preferably a configuration for attachment to a dental implant as described in relation to FIG. 1 is used, even more preferably substituted with a bearing element 140.

In FIG. 2, the longitudinal direction of the dental component is illustrated as being perpendicular to the longitudinal direction of the implant or implant analogue 111 and fastening element 115, the latter being in engagement with the implant or implant analogue 111. However, if the second subcomponent 122 rotates against the coronal bearing surface 133 of the first subcomponent 121, the coronal mouth of the through hole 126 is located in a plane that is tilted in relation to the longitudinal axis of the implant screw 115. In order to allow for fastening the fastening element 115, the apical bearing surface of the implant screw head is curved and preferably spherical.

Nonetheless, in order to allow the usage of a dental screw having a flat apical bearing surface, like the screws 15 and 16 shown in FIG. 1, a first washer 290 and a second washer 295 may be used as part of the dental component 120. As illustrated in FIG. 3, a first washer 290 having an apical bearing surface 292 and a coronal bearing surface 291 may be placed on the coronal side of the dental component 220.

In the exemplary embodiment illustrated in FIG. 3, the apical bearing surface 292 of the first washer 290 is basically formed as a flat surface, which facilitates a translation parallel to the flat coronal side or bearing surface of the dental component 220. When using the first washer 290 in combination with a fastening element as illustrated in FIG. 2, the dimension of the through hole 225 and, thus, the possible range of adjustment to compensate a misalignment and/or misplacement can be increased.

If a second washer 295 is provided in addition to the first washer 290, the coronal bearing surface 291 of the first washer 290 interacts with an apical bearing surface 296 of the second washer 295, which is placed coronally of the first washer 290. Said bearing surface 296 preferably has a shape that corresponds to the bearing surface 291 of the first washer 290. In the illustrated example, the bearing surface 291 is spherical just like the apical bearing surface 296 of the second washer 295. They preferably correspond to each other in order to provide a surface contact. The flat coronal bearing surface 297 of the second washer 295 allows for the use of a fastening element 215 having a flat apical bearing surface, like the fastening elements shown in FIG. 1.

While the implant screw 215 is tilted within the through hole of the dental component 220, the bearing surface 296 of the second washer 295 rotates accordingly against the bearing surface 291 of the first washer 290

The adjustment of the dental component 220 in relation to the at least one washer can be enhanced by appropriately choosing the cross section of the dental component's and washer's through holes and/or the geometry of their bearing surfaces. As illustrated in FIG. 3, a through hole passing through the second washer 295 has a diameter that is sufficient for the shaft of implant screw 215 to pass through and is yet small enough to provide sufficient support to the apical bearing surface of the screw's head. In contrast, a through hole of the first washer 290 is larger in diameter than the through hole of the second washer 295 since it has to provide sufficient space for the dental screw 30 and for the second washer 295 to be tilted therein. The same applies to the through hole of the subcomponent 220, i.e. it is larger in diameter than the through hole of the first washer 295 in order to allow for compensation of a misalignment and/or misplacement of the apical bearing surface of dental screw's head and the coronal surface of the dental component 220 caused by a misalignment and/or misplacement between a dental implant or implant analogue and said component 220.

The first washer 290, in particular in combination with a second washer 295, can also be applied to dental component 20 in combination with a bearing element 140. As mentioned above, this is also the preferred configuration of an implant screw being located at an end of a subcomponent 121, 122 that is not connected to another subcomponent.

For producing a dental prosthesis on the basis of a dental component 20, 120, 220 according to the present invention, the dental component is in a first step preferably preassembled as described above. This may be done at a production plant as a well as in a dental lab or the dental clinic. In any case, the pre-assembly of the dental components 20, 120, 220 does not require any chair time of the patient.

In a subsequent step, the dental component 20, 120, 220 is adjusted in relation to the position and orientation of the dental implants or dental implant analogues 11, 12, 111. This can be done as previously described in relation to the dental components 20 and 120 either directly on implants 11, 12, 111 that have been previously implanted in the upper or lower jawbone of a patient or indirectly using a model of the patient's dental situation.

In the direct approach, the relative position and orientation in between at least two implants and preferably three implants 11, 12, 111 can be recorded by locking the adjusted dental component 20, 120, 220 as previously described so that the recorded position and orientation can be transferred to a model using in particular implant analogues as will be described in more detail in the following.

Instead of recording the position and orientation of an implant 11, 12, 111 in relation to a dental component 20, 120 directly, it is also possible to use a transfer abutment 80 for this task. Such a transfer abutment 80 is shown in FIG. 4. Although FIG. 7 shows three transfer abutments 80, the number of abutments depends on the number of dental implants 11, 12, 111 implanted in the oral cavity of a patient. Thus, the number of abutments may be any number between 1 and 6.

In case of using transfer abutments 80, each implant 11, 12, 111 receives a transfer abutment 80 that is preferably fastened using a screw inserted into a through hole of the transfer abutment 80 and being engaged with a thread of a dental implant 11, 12, 111. After attaching a transfer abutment 80 to each implant 11, 12, 111, the abutments are brought in contact with each other with transfer abutment connections 81 such as the bars shown in FIG. 4. Once brought into contact with each other, the transfer abutments 80 are fixed or locked in relation to each other, preferably using a thermosetting polymer such as wax, acrylic or a resin. Most preferably, a cold or light curing resin suitable for intra-oral use is applied. After the thermosetting polymer is cured, the transfer abutments 80 can be removed from the dental implants 11, 12, 111 in the patient's oral cavity. In this state, the transfer abutments 80 and transfer abutment connections keep the recorded position and orientation of the at least one dental implant 11, 12, 111 in relation to at least another implant 11, 12, 111.

The recording of the relative positions of the implants 11, 12, 111 by one of the previously described two methods subsequently allows for the creation of a model by connecting implant analogues 11, 12, 111 to the transfer abutments 80. The position and orientation of the implant analogues 11, 12, 111 is then fixed using common cast techniques for anchoring the analogues relative to each other. More specifically, the implant analogues are integral with a moldable material after this material has set or cured.

If the affixing means is applied to the dental component 20, 120, 220 after the adjustment of the dental component on a model, the dental component 20, 120, 220 may be removed and the adjustment may be verified by placing this arrangement on the implants 11, 12, 111 in the mouth of a patient and preferably fixing this arrangement with an implant screw 115. This is particularly advantageous in case of using transfer abutments 80 in order to prevent any misfit that may have occurred after fixing and removing the transfer abutments 80 during recording of the relative position and orientation of the at least two implants.

During such a test, intraoral jaw relation records for the vertical dimension of occlusion (VDO) and centric relation (CR) may be obtained to register the occlusal relationship of the opposite dental arch to the dental component 20 and, if already applied, the modelling wax.

During production of the dental prosthesis, preferably a temporary screw with a long head (not shown) serves as as fastening element 15, 16, 115, 215 and as negative form for creating a screw channel within the material of a dental prosthesis, for example by applying wax-up techniques. During the creation of the dental prosthesis in the lab, the through holes of a dental component 20, 120, 220 are preferably attached to a corresponding number of implant analogues 80 of the previously created model representing the dental situation of the patient.

After casting the model in order to fixate the implant analogues 11, 12, 111, the creation of a dental prosthesis 24 on top of the dental component 20 may begin or continue using common techniques such as wax-up techniques.

Once the prosthesis is finished, the recorded position is maintained by the material of the dental prosthesis surrounding the dental component 20, 120, 220 so that the dental prosthesis including the dental component 20, 120, 220 can be attached to the at least one implant in the oral cavity of the patient. For example, the dental prosthesis can be engaged or snapped into place and fixed using a dental screw as fastening means 15, 16, 115. Thus, the only chair time needed with the patient may be for the recording of the position and orientation of the dental implants 11, 12, 111 and the attachment of the finished dental prosthesis to the implants.

Further, without the compensating effect of the dental component 20, 120, 220 a misalignment would result in a poor support or contact between the implant 11, 12, 111 and the dental component 20, 120, 220. Also, tension might be introduced into the dental implant 11, 12, 111 or the dental component 20. However, since the dental component 20, 120, 220 is able to compensate such a misalignment such an adverse scenario can successfully be prevented.

The recording of the position and orientation of the dental implant or dental implant analogue 11, 12, 111 in relation to the dental component 20, 120, 220 reduces the number of dental impressions necessary for making a dental restoration fit. In fact, any dental impressions after implantation can be avoided if the recording is performed within the mouth of the patient using the preassembled dental component 20, 120, 220. The same effect is achieved with transfer abutments 80 with transfer connections 81 so that the dental situation can be easily reproduced based on the position and orientation of a dental implant 11, 12, 111 recorded by the at least one transfer abutment. As will be appreciated by the skilled person, this method provides the same accuracy of fit as highly customized dental restorations without requiring the number of dental impressions needed for these restorations.

In contrast to other techniques known from the prior art, there is no need for any dental impressions after implantation of the implants when applying a method of the present invention. Thus, the present invention provides the means and methods for producing or making a dental prosthesis and installing the dental prosthesis with a minimum of chair time, low cost and barely any inconvenience caused to the patient.

The person skilled in the art will appreciate that the configurations of the dental components described in relation to the aforementioned figures merely represent presently preferred embodiments of the present invention. There are multiple modifications possible as already explained in detail above in relation to preferred embodiments of the invention.

### REFERENCE SIGNS

11, 111 dental implant or implant analogue
12 dental implant or implant analogue
15, 115 fastening element, in particular dental screw
16 dental screws, in particular implant screws
20, 120 dental component
21, 121 first dental subcomponent
22, 122 second dental subcomponent
23, 123 rotary bearing surface (concave) of rotary compensation means
24, 124 rotary bearing surface (concave) of rotary compensation means
25, 125 through hole for dental screw
26, 126 through hole for dental screw
30, 130 connecting device
31, 131 first part of the connecting device
32, 132 second part of the connecting device
33, 133 rotary bearing surface (convex) of rotary compensation means
34 rotary bearing surface (convex) of rotary compensation means
35 linear compensation means
50, 150 first rotary joint
60, 160 second rotary joint
70, 71 locking device
80 transfer abutment
81 transfer abutment connections
140 bearing element
141 through hole for dental screw
142 coronal rotary bearing surface (convex) of rotary compensation means
143 thread
215 fastening element or implant screw
220 dental component
290 first washer
291 coronal bearing surface of the first washer
292 apical bearing surface of the first washer
295 second washer
296 coronal bearing surface of the second washer
297 apical bearing surface of the second washers

1. A dental component forming the basis for at least a part of a prosthetic dental arch and comprising at least two subcomponents and a connecting device for compensating an offset in position or orientation between the subcomponents,
wherein each subcomponent includes a mounting portion for mounting the dental component on at least one dental implant or at least one dental implant analogue, and
wherein the connecting device comprises a rotary compensation means that connects the two dental subcomponents.

2. The dental component according to claim 1, wherein the rotary compensation means comprises a rotary joint.

3. The dental component according to claim 1, wherein the connecting device further comprises a linear compensation means for bridging a distance between the two dental subcomponents, the linear compensation means located between the two dental subcomponents.

4. The dental component according to claim 1, further comprising a bearing element for mounting one of the dental subcomponents to a dental implant or dental implant analogue, the bearing element having a bearing surface for interaction with a bearing surface of the dental subcomponent and a through hole in the apical-coronal direction.

5. The dental component according to claim 1, wherein each of the subcomponents comprises at least one hole in the apical-coronal direction for insertion of a dental screw.

6. The dental component according to claim 5, wherein the holes in the subcomponents form a part of the connecting device and are located so as to face each other in order to provide a through hole for insertion of a dental screw, wherein the apertures of the holes facing each other and the apical aperture of the hole of the subcomponent facing the dental implant or the dental implant analogue in an assembled state are each located within a rotary bearing surface.

7. The dental component according to claim 1, wherein the dental component comprises a third subcomponent and a second connection device, wherein the first and second subcomponents are coupled via the first connection device and the second and third subcomponents are coupled via the second connection device.

8. The dental component according to claim 1, further comprising at least one locking device for locking the connecting device in position or orientation.

9. A method for preassembling a dental component, the dental component including at least two elongated subcomponents, wherein the method comprises the steps of establishing a connection between the at least two subcomponents by assembling a first rotary joint of a connecting device and assembling a second rotary joint of the connecting device, wherein the assembled first and second rotary joints are maintained in an assembled state by bringing the rotary joints into engagement using a fastening element, a locking device or affixing means.

10. The method according to claim 9, wherein the fastening element is a dental screw engaging a bearing element of the second joint.

11. The method according to claim 9, further comprising the step of assembling a linear compensation means of the connecting device for adjusting the distance between the first rotary joint and the second rotary joint by bringing a first part including the first rotary joint into engagement with a second part including the second rotary joint, wherein the linear compensation means can be locked using a locking device.

12. A method for fitting a dental component to at least two dental implants or dental implant analogues for the production of a dental prosthesis, the method comprising the steps of
obtaining a dental component comprising at least two subcomponents, the two subcomponents being coupled by a connecting device;
mounting the subcomponents onto the dental implants or dental implant analogues; and
adjusting the connecting device to compensate for an offset in position or orientation between the two dental implants or dental implant analogues.

13. The method according to claim 12, further comprising the step of retaining the adjustment of the connecting device using a locking device or affixing means, wherein the affixing means is a thermosetting polymer.

14. The method according to claim 12, further comprising:
obtaining at least two, each transfer abutment corresponding to a dental implant and indicating the position or orientation of the dental implant, and
creating a working model by attaching an implant analogue to each transfer abutment and fixing the at least two implant analogues in the working model by embedding the dental implant analogue in a moldable material.

15. The method according to claim 12, further comprising the step of producing a dental prosthesis on the basis of the dental component with the subcomponents being fixed in relative position and orientation to each other and attached to the dental implant analogues (11, 12; 111) using a temporary screw.

16. The method according to claim 15, further comprising the step of fixing the dental prosthesis including the dental component to at least one dental implant implanted into the mandible or maxilla of a patient using implant screws.

17. The dental component according to claim 2, wherein the rotary joint comprises a ball and socket joint.

18. The dental component according to claim 4, wherein the through hole comprising a thread.

19. The dental component according to claim 5, wherein the at least one hole comprises a slotted hole.

20. The dental component according to claim 13, wherein the thermosetting polymer is chosen from at least one of the following: wax, acrylic, resin.
